(19) United States
(12) Patent Application Publication
(10) Pub. No.: US 2021/0322913 A1
(43) Pub. Date: Oct. 21, 2021

(54) AIR FILTER DIVERTER

(71) Applicant: Edward Gentile, Valley Stream, NY (US)

(72) Inventor: Edward Gentile, Valley Stream, NY (US)

(21) Appl. No.: 17/222,724

(22) Filed: Apr. 5, 2021

Related U.S. Application Data
(60) Provisional application No. 63/010,424, filed on Apr. 15, 2020.
(60) Provisional application No. 63/041,143, filed on Jun. 19, 2020.

(51) Int. Cl. B01D 46/00; F02M 35/024

(52) U.S. Cl. CPC B01D 46/0043; B01D 2279/60; F02M 35/02475

(57) ABSTRACT

An automobile air intake filter comprising: a filter, wherein the filter comprising a base portion a filtration unit and a top portion; and a diverter having a first end and second end, wherein the first end is secured to the base portion of the filter.

### CROSS-REFERENCE TO RELATED APPLICATIONS

This application is a continuation-in-part (and claims the benefit of priority under 35 USC 120) of U.S. application Ser. No. 15/044,817 filed Feb. 16, 2016 now abandoned. The disclosure of the prior applications is considered part of (and is incorporated by reference in) the disclosure of this application.

### BACKGROUND OF THE INVENTION

The present invention relates to an air filter diverter element inserted or integrated into an intake air filter for an automobile.

Air filters for the air intake conduit of an internal combustion engine are used in particular in motor vehicles in order to filter from the air carbon-particulate matter, pollen, particulates, and other particles contained in the ambient air so that these particles cannot reach the combustion chamber of the motor. A premature wear and damages, for example, due to scratch formation on the pistons or defects of electronic components, can be avoided by an effective filtration of the intake air. The present invention is concerned with the problem of providing a means of reducing the turbulence of the air that enters the filter and is then redirected into the engine.

The features and filter design choices that lead to improvements in one of these parameters (e.g., particle entrapment, airflow permeability, and filter lifetime) can lead to declines in the other performance parameters. Thus, filter design involves trade-offs among features achieving high filter efficiency, and features achieving a high filter capacity and concomitant long filter lifetime.

As used herein, filter efficiency is the propensity of the filter media to trap, rather than pass, particulates. Filter capacity is typically defined according to a selected limiting pressure differential across the filter, typically resulting from loading by trapped particulates. Volumetric filter flow rate, or flow rate, is a measure of the volume of air that can be drawn into a given filter having a particular effective filter area, efficiency, and capacity, at a particular point in the expected filter lifetime. However, once the air is drawn into the filter, the air has no clear path to the inlet tube and thus within the filter there is a high degree of turbulence of the air, this results in a lose of power, decrease in milage, and excess stress on vital engine components.

This invention is based on the general idea of taking the air which is entering the filter, and creating a smooth air flow transition from the filter to the inlet tube.

### SUMMARY

Accordingly, it is an objective of the present invention an automobile air intake filter comprising: a filter, wherein the filter comprising a base portion a filtration unit and a top portion; and a diverter having a first end and second end, wherein the first end is secured to the base portion of the filter.

### BRIEF DESCRIPTION OF THE DRAWINGS

FIG. 1 depicts an isometric view of a filter with a diverter, in accordance with one embodiment of the present invention.

FIG. 2 depicts a top view of a filter with a diverter, in accordance with one embodiment of the present invention.

FIG. 3 depicts an isometric view of a filter with a diverter, in accordance with one embodiment of the present invention.

FIG. 4 depicts an illustration of the diverter's effect on the airflow within the filter, in accordance with one embodiment of the present invention.

### DETAILED DESCRIPTION OF THE INVENTION

The present invention provides for an improved automobile air filter, or an aftermarket air filter component to improve the efficiency of the engine by creating a smoother, less turbulent air flow from the ambient air through the filter and into the engine. The air diverter is able to redirect the air once within an internal cavity of an air filter to create a more direct path for the air and reduce the turbulence of the air within the filter. This is advantageous because it improves the laminar conditions within the air filter, but also increase the air flow and air velocity based on the path created by the diverter. On the road this translates to more power with a smoother delivery as well as sharper throttle response since the airflow is not inhibited by abrupt geometry changes and so is more likely to remain laminar. The figures show the diverter installed on a filter, but may be installed on preexisting air filters.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

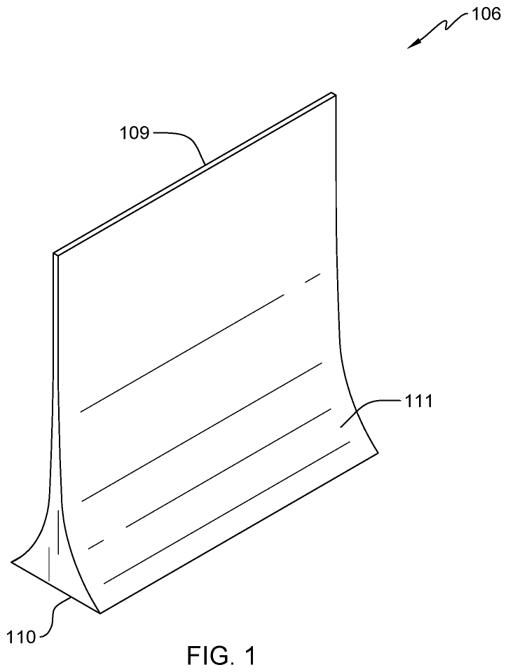

FIG. 1 depicts an image of an air filter element, in accordance with a first embodiment. The air filter 100 is affixed to an upstream portion of air intake tubing. Filter element 100 has a top seal 102, may comprise a synthetic resin, such as a polyurethane resin, a filtration unit 103, a base sealing ring 104, may comprise a synthetic resin, such as a polyurethane resin. The filtration unit 103 defines an internal void 101. The filtration unit 103 may be generally or substantially oval in shape, for example, filter element 103 may resemble and oval shape and design. Filter element 103 may be adapted for filtering ambient air, and for providing an adequate volume, or flow rate, of filtered air to turbochargers and internal combustion engines.

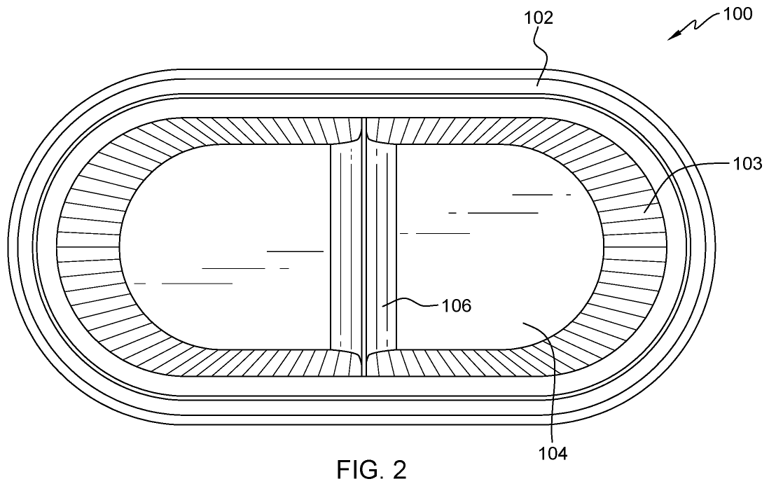

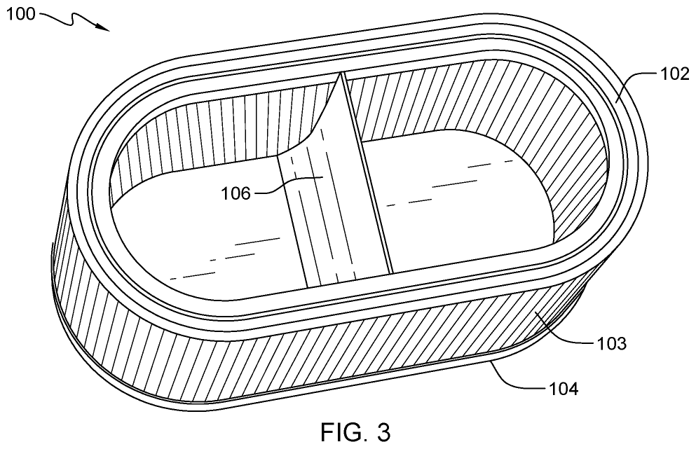

With reference to FIGS. 2 and 3 are views of an intake filter 100. The intake filter 100 is comprised of a filter element 103, a base sealing ring 104, a top seal 102, and a diverter 106. The diverter 106 may be made from a flexible, rigid, or semi-rigid material based on the intended operation of the diverter 106, and the filter 100 design and requirements. The filter element 103, as seen from the top of filter element 103. Filter element 103 may include a top sealing 102 at a top portion 105 of filter element 103, and a base sealing ring 104 at a base portion 106 of filter element 103. Top sealing 102 and top portion 105 may be oval or substantially circular, provided than an internal void 101 is created. The base sealing ring 104 is designed to securely connect with an intake system of a vehicle or the engine of the vehicle based on the vehicle intake system design. Filter element 103 may have multiple filtration systems or layers based on the design. Placed within the internal void 101 is a diverter 106. The diverter 106 is designed to fit against the base sealing ring 104 and has a curved end 107 which extends a predetermined distance within the internal void 101 and has a substantially flat and thin design. The diverter 106, is attached or integrated into the base sealing ring 104 to form a substantially airtight seal between the diverter 106 and the base sealing ring 104. The diverter extends the entire width of the filter, creating two substantially equal sections within the internal void 101. The diverter 106, in the depicted embodiment is the same height as the filter element 103, to create to separate sections within the internal void 101. The diverter 106 has a substantially straight design, with an oversized base to accommodate the convex design. The curvature of the diverter 106 may be adjusted based on the filter 100 design, the idle air flow into the engine, and other environmental aspects that change with each engine design, the volume of air flow, and the speed of the air flow.

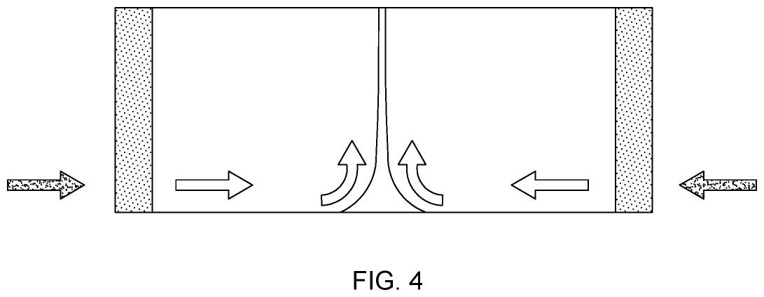

FIG. 4 is a longitudinal sectional view of the filter with the diverter 106, with arrows indicating the direction of flow of ambient or unfiltered air through the filter element 103 and interacting with the diverter 106. As the air enters the internal void 101, the air is redirected by the diverter 106 into the engine. Without the diverter 106, the air within the internal void 101 is extremely turbulence and has little direction. This sudden transition in geometry is detrimental for flow and results in wasted/lost power, efficiency of the engine, and the overall performance of the engine is reduced. With the addition of the diverter 106, the air entering the internal void 101 enters the air filter 100, but as the air is swirled around within the internal void 101, the air comes in contact with the diverter 106, which redirects the air towards the opening in the base sealing ring 104. The diverter 106 creates a smooth transition of the external air through the filter and into the engine. The laminar conditions throughout the intake with the diverter 106 is more efficient than previous designs. This smooth redirection based on the curved profile design of the diverter 106 improves the laminar conditions of the air within the internal void 101 and creates a more consistent and direct flow of air into the engine The curved end 107 of the diverter 106 is designed based on the intake filter 100 design to best improve the air flow based on the size and shape of the intake filter 100. The radius of the curved end, and the thickness of the diverter 106 are based on the filter 100 properties. In the depicted embodiment, the curved end 107 has a convex shape. In other embodiments the profile and curvature of the diverter 106 may be adjusted based on the filter 100 design and the air flow characteristics.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

Providing filtered air to the internal combustion engine according to embodiments of the present invention may improve engine performance, for example, by increasing horsepower, torque, and/or fuel economy by creating a path of least resistance for the air.

It should be understood, of course, that the foregoing relates to exemplary embodiments of the invention and that modifications may be made without departing from the spirit and scope of the invention as set forth in the following claims.

What is claimed is:

1. An automobile air intake filter comprising:
a filter, wherein the filter comprising a base portion a filtration unit and a top portion; and
a diverter having a first end and second end, wherein the first end is secured to the base portion of the filter.

2. The automobile air intake filter of claim 1, wherein the first end has a concave design.

3. The automobile air intake filter of claim 1, wherein the diverter extends to the top portion of the filter.

4. The automobile air intake filter of claim 1, wherein the diverter is in contact with the filtration unit along a first and second edge.

5. The automobile air intake filter of claim 1, wherein the top portion of the filter has an opening, wherein the opening is sized to fit an intake of an engine.

6. The automobile air intake filter of claim 1, wherein the filter has an oval shape, and the diverter is positioned substantially along a centerline of the filter.

7. The automobile air intake filter of claim 1, wherein the diverter is positioned within the filter based on an air flow into the filter.

8. An automobile air intake filter diverter comprising: a diverter wherein the diverter has a first end and a second end and a first edge and a second edge, and wherein the first end of a convex design and is sized to fit within an air filter.

9. The automobile air intake filter diverter of claim 8, wherein the diverter is made from a semi-rigged material.

10. The automobile air intake filter diverter of claim 8, wherein a curved portion of the first end extends a predetermined distance towards the second end.

11. The automobile air intake filter diverter of claim 8, wherein the diverter has a substantially linear design.
